(19) United States
(12) Patent Application Publication
(10) Pub. No.: US 2026/0105659 A1
(43) Pub. Date: Apr. 16, 2026

(54) BLENDING DIGITAL ASSETS WITH PLANAR SURFACES USING IMAGE SEGMENTATION AND CORNER DETECTION

(71) Applicant: Adobe Inc., San Jose, CA (US)

(72) Inventors: Aajay Ayyappan Devaraj, New Delhi (IN); Sumit Dhingra, New Delhi (IN); Ashish Jindal, Delhi (IN); Vineet Batra, Pitam Pura (IN)

(21) Appl. No.: 18/917,422

(22) Filed: Oct. 16, 2024

(51) Int. Cl. G06T 11/60; G06T 5/20; G06T 7/12; G06T 7/13; G06V 10/46; G06V 10/764; G06V 20/70

(52) U.S. Cl. CPC G06T 11/60; G06T 5/20; G06T 7/12; G06T 7/13; G06V 10/46; G06V 10/764; G06V 20/70; G06T 2207/20081; G06T 2207/20084

(57) ABSTRACT

Methods, systems, and non-transitory computer readable storage media are disclosed for detecting and editing planar surfaces in digital images utilizing automatic segmentation and corner detection. The disclosed system generates, utilizing a segmentation neural network, a segmentation mask of a planar surface in a digital image. The disclosed system determines, utilizing a corner detection model, coordinates of corners of the planar surface from an outer contour extracted from the segmentation mask. The disclosed system also generates, for display via a graphical user interface displaying the digital image, a modified digital image comprising a digital asset inserted onto the planar surface by performing a perspective transformation on the digital asset utilizing a transformation matrix determined from the coordinates of the corners of the planar surface.

### BACKGROUND

Many tasks involving digital media utilize combinations of digital images to create digital content for many different scenarios. For example, many entities utilize mockup images including representations of prototypes, products, or concepts for creating proof of concepts. Specifically, such mockup images typically involve a combination of a base image including a specific context for representing a specific asset, often using vector images for lossless scaling for creating high quality images in different resolutions. Accordingly, accurately combining digital images (e.g., by inserting a digital asset such as a decal into a digital image at a particular location) while ensuring realistic, seamless blending is an important and often time-consuming aspect of digital design operations.

### SUMMARY

One or more embodiments provide benefits and/or solve one or more of the foregoing or other problems in the art with systems, methods, and non-transitory computer readable storage media for inserting digital assets on planar surfaces detected in digital images using a segmentation neural network with corner detection. In particular, the disclosed systems utilize a segmentation neural network to generate a segmentation mask of a planar surface in a digital image. In one or more embodiments, the disclosed systems train the segmentation neural network utilizing a dataset including images indicated as containing planar surfaces by a classifier model. Furthermore, the disclosed systems perform post-processing operations of detecting corners of the planar surface utilizing a corner detection algorithm on the segmentation mask. The disclosed systems generate a transformation matrix utilizing the detected corners to apply a perspective transformation to a digital asset to insert the digital asset into the digital image on the planar surface. The disclosed systems thus provide efficient, accurate, automated insertion of digital assets on planar surfaces in digital images.

### BRIEF DESCRIPTION OF THE DRAWINGS

Various embodiments will be described and explained with additional specificity and detail through the use of the accompanying drawings.

FIG. 1 illustrates an example system environment in which a planar surface detection system operates in accordance with one or more implementations.

FIG. 2 illustrates a diagram of an overview of the planar surface detection system utilizing automatic segmentation with post-processing operations to insert a digital asset into a digital image in accordance with one or more implementations.

FIG. 3 illustrates a diagram of the planar surface detection system generating a segmentation mask for a planar surface in a digital image and detecting corners of the planar surface from the segmentation mask to transform a digital asset for modifying the digital image in accordance with one or more implementations.

FIG. 4 illustrates a diagram of the planar surface detection system detecting corners of a planar surface of a digital image utilizing a corner detection algorithm in accordance with one or more implementations.

FIG. 5 illustrates a diagram of the planar surface detection system determining coordinates of corners by filtering lines detected in a segmentation mask in accordance with one or more implementations.

FIG. 6 illustrates a diagram of the planar surface detection system applying a perspective transformation to a digital asset using detected corners of a planar surface in accordance with one or more implementations.

FIG. 7A illustrates a graphical user interface for editing a digital image by inserting a digital asset on a planar surface in accordance with one or more implementations.

FIG. 7B illustrates a graphical user interface for editing a digital image by inserting a digital asset on a planar surface in accordance with one or more implementations.

FIG. 7C illustrates a graphical user interface for editing a digital image by inserting a digital asset on a planar surface in accordance with one or more implementations.

FIG. 8 illustrates a diagram of the planar surface detection system generating a modified training dataset for training a segmentation neural network in accordance with one or more implementations.

FIG. 9 illustrates a diagram of the planar surface detection system training a segmentation neural network in accordance with one or more implementations.

FIG. 10 illustrates a diagram of an example of the planar surface detection system in accordance with one or more implementations.

FIG. 11 illustrates a flowchart of a series of acts for inserting a digital asset on a planar surface in a digital image utilizing a segmentation neural network and corner detection in accordance with one or more implementations.

FIG. 12 illustrates a block diagram of an exemplary computing device in accordance with one or more implementations.

### DETAILED DESCRIPTION

One or more embodiments of the present disclosure include a planar surface detection system that automatically inserts digital assets on planar surfaces of digital images utilizing a segmentation neural network and corner detection with perspective transformation. Conventional systems have a number of disadvantages with respect to inserting digital assets into digital images. For example, existing systems lack the ability to efficiently and accurately blend multiple digital images without significant trade-offs. Specifically, some conventional systems provide tools for distorting or transforming digital assets when inserting the digital assets into digital images. Although such tools provide a high degree of control to users editing digital images, the tools require significant expertise and are often time consuming to use. Additionally, these tools are prone to inaccuracies on the boundaries of digital assets inserted into digital images.

Some conventional systems provide tools for applying vector graphics onto three-dimensional objects. In particular, some conventional systems allow for the placement of digital assets onto three-dimensional surfaces without explicit three-dimensional modeling of the surfaces or digital assets. For instance, some conventional systems use monocular depth prediction with vector projection to visualize vector designs on real-world objects with resolution independence. Although such systems are capable of generating blended images in some scenarios, the systems lack the ability to detect and accurately transform planar surfaces due to the nature of such surfaces, particularly when such surfaces are artificially placed (e.g., in mockup images where the planar surfaces are artificially placed on real-world objects in base images). More specifically, these conventional systems are limited due to the training of depth estimation models using predominantly real-life image data, resulting in failures to generalize for mockup scenarios.

As mentioned, in one or more embodiments, the planar surface detection system utilizes a segmentation neural network to automatically segment planar surfaces in images. Specifically, the planar surface detection system trains the segmentation neural network to detect planar surfaces in digital images and generate segmentation masks for the detected planar surfaces. In one or more embodiments, the planar surface detection system generates a training dataset for training the segmentation neural network by utilizing a classifier model to filter by images that include planar surfaces. For example, the training dataset includes mockup images with surfaces for displaying logos, pictures, decals, etc. Additionally, in some embodiments, the planar surface detection system augments the filtered images utilizing one or more image filters (e.g., a multiply blending filter) or transformation operations.

In one or more embodiments, the planar surface detection system utilizes the trained segmentation neural network to generate a segmentation mask for a planar surface of a digital image. Additionally, the planar surface detection system utilizes post-processing operations to determine corners of the planar surface according to the segmentation mask. For example, the planar surface detection system utilizes a corner detection algorithm to detect lines from edges in the segmentation mask. The planar surface detection system also utilizes the corner detection algorithm to determine coordinates of corners from intersections of the detected lines.

In additional embodiments, the planar surface detection system utilizes the detected corners to perform a perspective transformation operation on the digital asset. In particular, the planar surface detection system generates a transformation matrix to apply to the digital asset with a perspective transformation operation (e.g., via a tool in a digital image application). Accordingly, the planar surface detection system automatically detects planar surfaces in digital images via a segmentation neural network and inserts digital assets on the planar surfaces utilizing post-processing operations of corner detection and perspective transformation.

The planar surface detection system provides a number of advantages over conventional systems in connection with editing digital images, particularly in connection with inserting digital assets into digital images in mockup scenarios. For example, the planar surface detection system improves an accuracy and efficiency of a computing device in connection with detecting planar surfaces in digital images. In contrast to conventional systems that utilize user-based tools to outline specific locations of digital images for inserting digital assets, the planar surface detection system automatically detects planar surfaces for insertion of digital assets via a segmentation neural network with post-processing operations to refine segmentation masks. Specifically, the planar surface detection system utilizes machine-learning segmentation with post-processing operations of accurately detecting corners of the segmentation masks. Furthermore, the planar surface detection system generates a transformation matrix according to the detected corners to execute perspective transformation operations on a digital asset, resulting in more accurate perspective modification of the digital asset for insertion on the planar surface as compared to the conventional systems.

The planar surface detection system also provides accuracy and flexibility in detecting planar surfaces of digital images via training of a segmentation neural network. In contrast to conventional systems that rely on pre-compiled or prepared images for image editing in mockup scenarios, the planar surface detection system leverages a trained segmentation neural network to automatically detect planar surfaces in a variety of different digital images in real-time. In particular, the planar surface detection system generates and utilizes a dataset of digital images classified as including planar surfaces to train the segmentation neural network to detect planar surfaces in any digital image. More specifically, by utilizing a classifier model to generate a modified training dataset by filtering planar surface images and applying various augmentations to the planar surface images for training the segmentation neural network on different scenarios. In some embodiments, training the segmentation neural network with filtered images including planar surfaces also provides accurate detection of planar surfaces (e.g., white mockup planar surfaces) inserted into digital images.

In additional embodiments, the planar surface detection system provides improved accuracy of additional digital content editing or generation processes. For instance, by accurately detecting corners of planar surfaces, the planar surface detection system improves construction of three-dimensional depth meshes. The planar surface detection system improves the realism and quality of three-dimensional models via better refinement of depth meshes. Additionally, the planar surface detection system addresses limitations of conventional depth estimation systems, especially in understanding planar surfaces in mockup scenarios via precise corner detection. The planar surface detection system also provides seamless integration of virtual objects into augmented or virtual reality environments, thus improving realism of augmented or virtual reality environments.

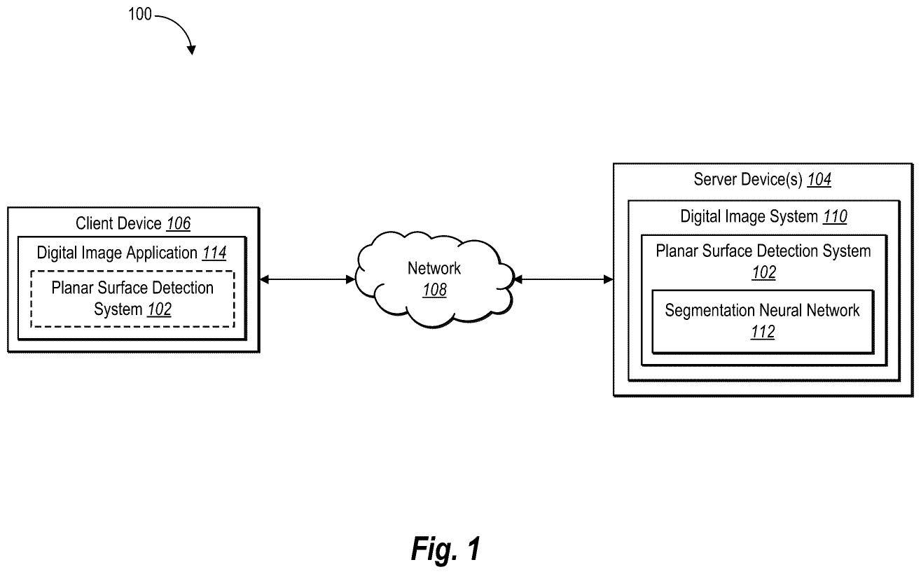

Turning now to the figures, FIG. 1 includes an embodiment of a system environment 100 in which a planar surface detection system 102 is implemented. In particular, the system environment 100 includes server device(s) 104 and a client device 106 in communication via a network 108. Moreover, as shown, the server device(s) 104 include a digital image system 110, which includes the planar surface detection system 102. Furthermore, in some embodiments, the digital image system 110 also includes a segmentation neural network 112. Additionally, the client device 106 includes a digital image application 114, which optionally includes the planar surface detection system 102 (or the digital image system 110).

As shown in FIG. 1, the client device 106 or the server device(s) 104 include or host the digital image system 110. The digital image system 110 includes, or is part of, one or more systems that implement digital image generation or editing operations. For example, the digital image system 110 provides tools for generating or editing digital images (e.g., vector images and/or raster images). To illustrate, the digital image system 110 communicates with the client device 106 via the network 108 to provide the tools for display and interaction via the digital image application 114 at the client device 106. Additionally, in some embodiments, the digital image system 110 receives requests to access digital image data stored (e.g., at the server device(s) 104 or at another device such as a database) and/or requests to store digital image data. In some embodiments, the digital image system 110 receives interaction data for viewing or performing various image processing operations and provides the results of the interaction data (e.g., generated digital image data) for display via the digital image application 114 or to a third-party system. In additional embodiments, the digital image system 110 provides tools for generating data (e.g., training data) for various downstream operations (e.g., training the segmentation neural network 112).

According to one or more embodiments, the digital image system 110 utilizes the planar surface detection system 102 to generate, edit, or otherwise process digital images in connection with inserting digital assets into the digital images. In particular, the planar surface detection system 102 utilizes the segmentation neural network 112 to segment planar surfaces in the digital images. Additionally, the planar surface detection system 102 utilizes post-processing operations to detect corners in the planar surfaces. In additional embodiments, the planar surface detection system 102 performs post-processing operations to apply perspective transformations to digital assets for inserting the digital assets on the planar surfaces of the digital images. Furthermore, in some embodiments, the planar surface detection system 102 provides generated results (e.g., modified digital images) to the client device 106, such as via the digital image application 114.

As illustrated in FIG. 1, the planar surface detection system 102 is implemented on the client device 106 or on the server device(s) 104. In particular, in some implementations, the planar surface detection system 102 on the server device(s) 104 supports the planar surface detection system 102 on the client device 106. For instance, the server device(s) 104 generates or obtains the planar surface detection system 102 (e.g., including training the segmentation neural network 112) for the client device 106 (e.g., as part of a software application or suite). The server device(s) 104 provides the planar surface detection system 102 to the client device 106 for performing digital image editing processes at the client device 106. In other words, the client device 106 obtains (e.g., downloads) the planar surface detection system 102 from the server device(s) 104. At this point, the client device 106 is able to utilize the planar surface detection system 102 to edit digital images independently from the server device(s) 104.

In additional embodiments, although FIG. 1 illustrates the server device(s) 104 and the client device 106 communicating via the network 108, the various components of the system environment 100 communicate and/or interact via other methods (e.g., the server device(s) 104 and the client device 106 communicate directly). Furthermore, although FIG. 1 illustrates the planar surface detection system 102 being implemented by a particular component and/or device within the system environment 100, the planar surface detection system 102 is implemented, in whole or in part, by other computing devices and/or components in the system environment 100. For example, in some embodiments, the server device(s) 104 include or host the digital image system 110 and/or the planar surface detection system 102.

To illustrate, the planar surface detection system 102 includes a web hosting application that allows the client device 106 to interact with content and services hosted on the server device(s) 104 (e.g., in a software as a service implementation). To illustrate, in one or more implementations, the client device 106 accesses a web page supported by the server device(s) 104. The client device 106 provides input to the server device(s) 104 to view information for image editing tasks and, in response, the planar surface detection system 102 or the digital image system 110 on the server device(s) 104 performs operations to edit or process digital images. The server device(s) 104 provide the output or results of the operations to the client device 106.

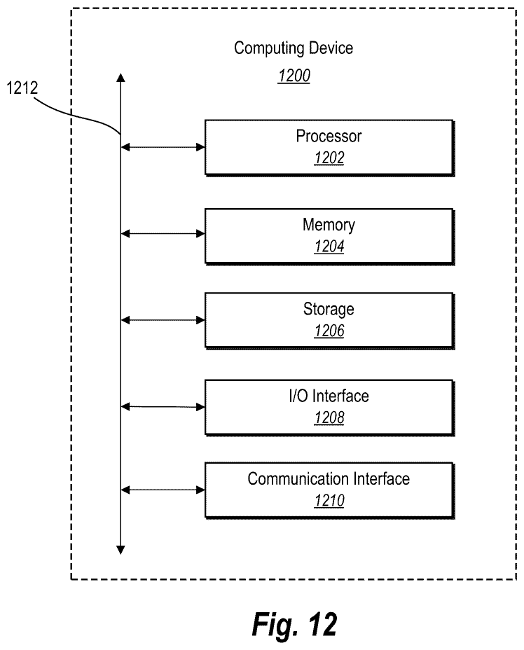

In one or more embodiments, the server device(s) 104 include a variety of computing devices, including those described below with reference to FIG. 12. For example, the server device(s) 104 include one or more servers for storing and processing data associated with image editing processes. In some embodiments, the server device(s) 104 also include a plurality of computing devices in communication with each other, such as in a distributed storage environment. In some embodiments, the server device(s) 104 include a content server. The server device(s) 104 also optionally include an application server, a communication server, a web-hosting server, a social networking server, a digital content campaign server, or a digital communication management server.

In addition, as shown in FIG. 1, the system environment 100 includes the client device 106. In one or more embodiments, the client device 106 includes, but is not limited to, a mobile device (e.g., smartphone or tablet), a laptop, a desktop, including those explained below with reference to FIG. 12). Furthermore, although not shown in FIG. 1, the client device 106 is operable by a user (e.g., a user included in, or associated with, the system environment 100) to perform a variety of functions. In particular, the client device 106 performs functions such as, but not limited to, accessing, viewing, generating, and editing digital images. In some embodiments, the client device 106 also performs functions for generating, capturing, or accessing data to provide to the digital image system 110 and the planar surface detection system 102 in connection with editing digital images. For example, the client device 106 communicates with the server device(s) 104 via the network 108 to provide information (e.g., user interactions) associated with digital images. Although FIG. 1 illustrates the system environment 100 with a single client device, in some embodiments, the system environment 100 includes a different number of client devices.

Additionally, as shown in FIG. 1, the system environment 100 includes the network 108. The network 108 enables communication between components of the system environment 100. In one or more embodiments, the network 108 may include the Internet or World Wide Web. Additionally, the network 108 optionally include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server device(s) 104 and the client device 106 communicates via the network using one or more communication platforms and technologies suitable for transporting data and/or communication signals, including any known communication technologies, devices, media, and protocols supportive of data communications, examples of which are described with reference to FIG. 12.

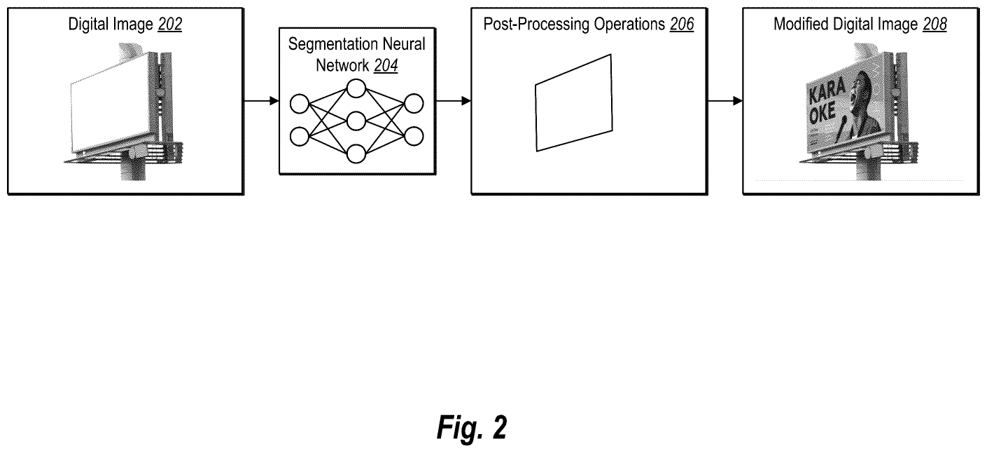

As mentioned, the planar surface detection system 102 utilizes machine-learning to segment planar surfaces in digital images for inserting digital assets into the digital images. FIG. 2 illustrates an overview diagram of the planar surface detection system utilizing a segmentation neural network with post-processing operations to modify a digital image. Specifically, the planar surface detection system detects planar surfaces utilizing the segmentation neural network and utilizes the post-processing operations to detect corners for transforming a digital asset.

In one or more embodiments, the planar surface detection system 102 determines a digital image 202 including one or more objects arranged in a scene. More specifically, the digital image 202 includes at least one object with a planar surface. For example, the digital image 202 includes a mockup image of an object with a flat, quadrilateral surface on at least one side of the object. Examples of such a planar surface include billboard surface, a flat portion of a frame for photographs, a screen portion of a mobile phone or tablet, a screen of a monitor or television, etc. Furthermore, in one or more embodiments, the digital image 202 includes a planar surface digitally inserted onto a flat portion of an object, such as a white quadrilateral inserted into the digital image 202 on a surface of an object via one or more image editing operations (e.g., in connection with generating one or more mockup images).

In one or more embodiments, the planar surface detection system 102 receives a request to detect a planar surface in the digital image 202 in connection with inserting a digital asset onto the planar surface of the digital image 202. For example, a digital asset includes a separate digital image or digital video (e.g., a video container) to insert into the digital image 202. In some embodiments, a digital asset includes a vector image such as a decal representing a logo, advertisement, etc. Accordingly, in some embodiments, a request to insert a digital asset on a planar surface of a digital image corresponds to image editing operations for generating a mockup image.

As illustrated in FIG. 2, the planar surface detection system 102 utilizes a segmentation neural network 204 to segment one or more planar surfaces in the digital image 202. In one or more embodiments, a neural network includes a machine learning model that is trainable and/or tunable based on inputs to determine classifications and/or scores, or to approximate unknown functions. For example, in some cases, a neural network includes a model of interconnected artificial neurons (e.g., organized in layers) that communicate and learn to approximate complex functions and generate outputs based on inputs provided to the neural network. In some cases, a neural network refers to an algorithm (or set of algorithms) that implements deep learning techniques to model high-level abstractions in data. A neural network includes various layers such as an input layer, one or more hidden layers, and an output layer that each perform tasks for processing data. For example, a neural network includes a deep neural network, a convolutional neural network, a diffusion neural network, a recurrent neural network (e.g., an LSTM), a graph neural network, a transformer, or a generative adversarial neural network.

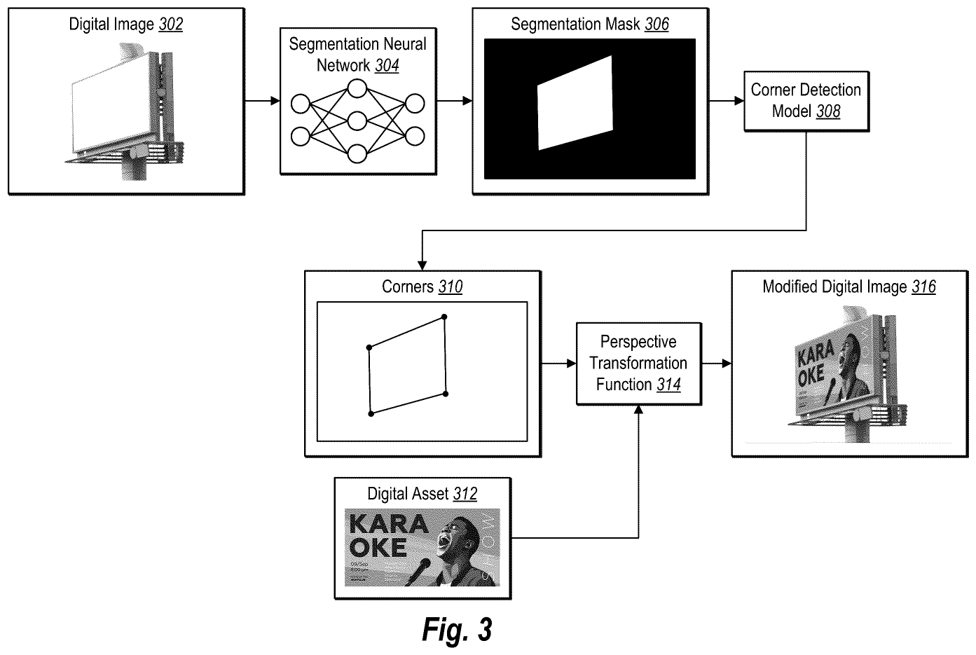

In one or more embodiments, the segmentation neural network 204 includes one or more encoder layers and one or more decoder layers to generate segmentations and/or segmentation masks corresponding to detected objects in a digital image according to trained parameters (e.g., for detecting certain types of objects such as planar surfaces). For example, in some embodiments, the segmentation neural network 204 includes a convolutional neural network with a plurality of encoding layers and a plurality of decoding layers connected via a plurality of skip connections. FIG. 3 and the corresponding description provide additional detail related to utilizing a segmentation neural network to detect planar surfaces in a digital image.

Furthermore, as illustrated in FIG. 2, the planar surface detection system 102 utilizes post-processing operations 206 to refine a segmentation generated by the segmentation neural network 204 and insert a digital asset into the digital image 202. Specifically, the planar surface detection system 102 utilizes corner detection to detect corners of a planar surface in the digital image 202. Additionally, the planar surface detection system 102 utilizes perspective transformation to modify a digital asset for inserting on the planar surface based on the detected corners. Accordingly, the planar surface detection system 102 generates a modified digital image 208 including the digital asset via the post-processing operations 206. FIGS. 3-6 and the corresponding description provide additional detail with respect to the post-processing operations 206.

As mentioned, the planar surface detection system 102 utilizes image segmentation with post-processing operations to insert a digital asset into a digital image. FIG. 3 illustrates that the planar surface detection system 102 utilizes a segmentation neural network with a plurality of separate post-processing operations to modify a digital image. In particular, FIG. 3 illustrates that the planar surface detection system 102 utilizes automatic corner detection with a perspective transformation function from a digital image application to insert a digital asset on a planar surface of a digital image.

In one or more embodiments, in response to a request to, or otherwise in connection with, a request to modify a digital image 302 (e.g., by inserting digital content into the digital image 302), the planar surface detection system 102 utilizes a segmentation neural network 304 to detect a planar surface in the digital image 302. As illustrated in FIG. 3, the planar surface detection system 102 utilizes the segmentation neural network 304 to generate a segmentation mask 306 for a planar surface. More specifically, the segmentation neural network 304 generates the segmentation mask 306 including values that indicate a region including the planar surface and values that indicate one or more regions outside the planar surface. To illustrate, the segmentation mask 306 includes pixel values of 1 corresponding to the area of the planar surface and pixel values of 0 corresponding to the portions of the digital image 302 outside the planar surface.

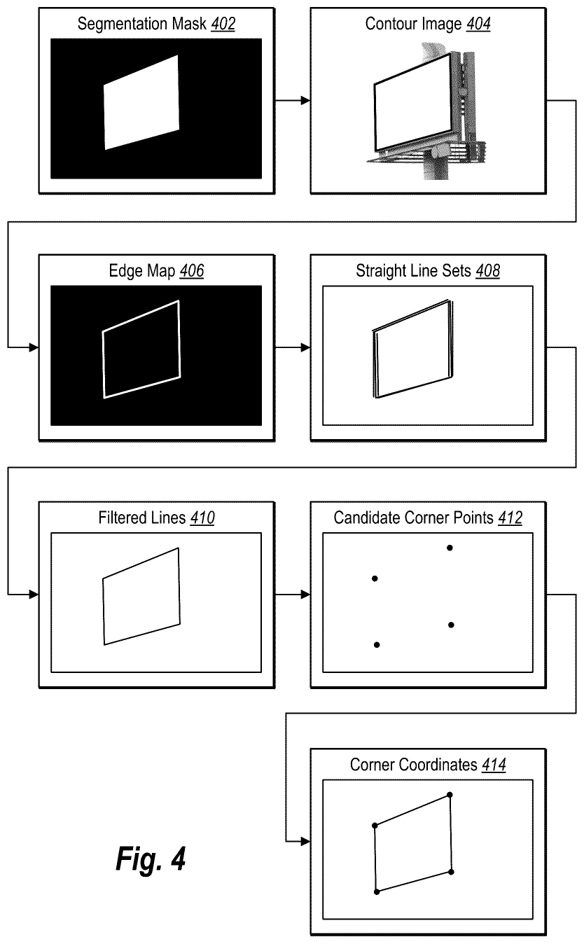

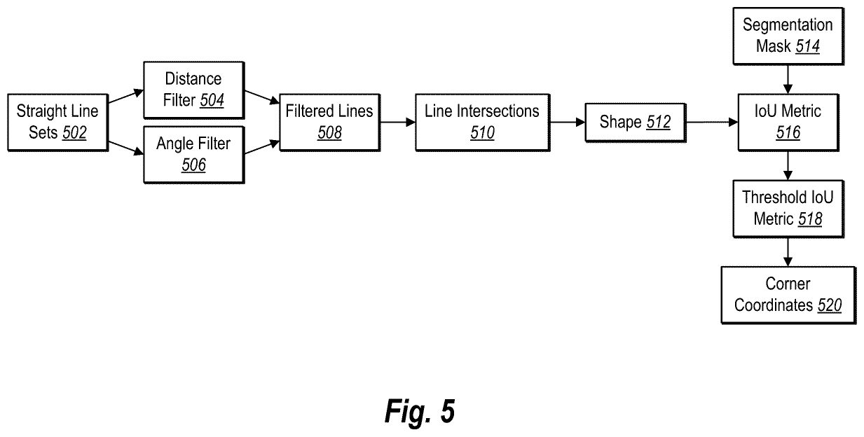

In response to generating the segmentation mask 306, in one or more embodiments, the planar surface detection system 102 utilizes a corner detection model 308 to perform automatic corner detection for the planar surface. Specifically, the planar surface detection system 102 utilizes the corner detection model 308 to refine the boundaries of the planar surface in the segmentation mask 306 for more accurate detection of the planar surface in the digital image 302. In one or more embodiments, the corner detection model 308 includes a corner detection algorithm that detects corners via contour detection, edge detection, line transforms, and/or additional operations, as described in more detail with respect to FIGS. 4-5. In additional embodiments, the corner detection model 308 includes a corner detection algorithm that utilizes a ratio of parallelogram diagonals to estimate curve curvature for contour-based corner detection.

According to one or more embodiments, the planar surface detection system 102 determines corners 310 via the corner detection model 308. In particular, the planar surface detection system 102 determines coordinates of corners 310 of the planar surface in the digital image 302. More specifically, the coordinates of the corners 310 correspond to corners of the segmentation mask 306 that indicates the boundaries of the planar surface. Thus, the planar surface detection system 102 refines the segmentation mask 306 to accurately determine the corners 310 and their corresponding coordinates (e.g., pixel coordinates in a raster image space or relative positions of the corners in a vector image space).

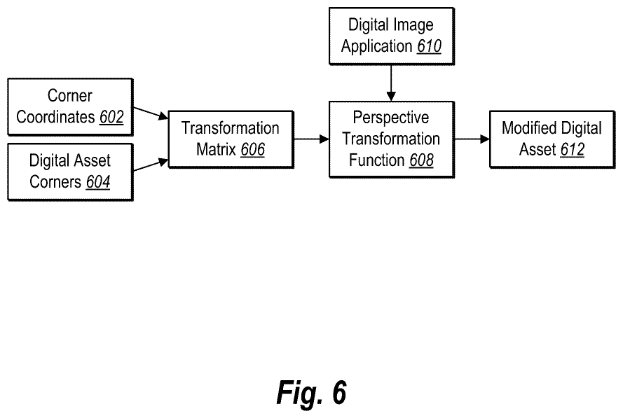

In one or more embodiments, as illustrated in FIG. 3, the planar surface detection system 102 performs additional post-processing operations by utilizing the corners 310 to transform a digital asset 312 to fit on the planar surface. For example, the planar surface detection system 102 utilizes a perspective transformation function 314 to transform a perspective of the digital asset 312 based on the coordinates of the corners 310. To illustrate, the planar surface detection system 102 generates a transformation matrix based on the corners 310 for use in executing the perspective transformation function 314 to insert the digital asset 312 into the digital image 302 on the planar surface (e.g., such that boundaries of the digital asset 312 correspond to boundaries of the planar surface), as described in more detail with respect to FIG. 6. In one or more embodiments, the perspective transformation function 314 includes a function of a digital image application, such that the planar surface detection system 102 executes the perspective transformation function 314 via an integration with the digital image application (e.g., via an application programming interface call or direct execution of the perspective transformation function 314).

The planar surface detection system 102 thus generates a modified digital image 316 that includes the digital asset 312 inserted into the digital image 302 on the planar surface. In one or more embodiments, the planar surface detection system 102 generates the modified digital image 316 in response to a request to insert the digital asset 312 into a planar surface of the digital image 302 without further user interaction with a graphical user interface. In some embodiments, the planar surface detection system 102 provides an indication of one or more planar surfaces detected in the digital image 302 and inserts the digital asset 312 into the digital image 302 in response to a selection of a particular planar surface and/or an indication of the digital asset 312.

As mentioned, in one or more embodiments, the planar surface detection system 102 utilizes a corner detection algorithm to detect corners for a planar surface based on a segmentation indicating the planar surface. FIG. 4 illustrates an example process in which the planar surface detection system 102 detects corners via a plurality of post-processing operations for detecting corners based on a segmentation mask of a planar surface.

As illustrated in FIG. 4, the planar surface detection system 102 generates a segmentation mask 402 for a planar surface in a digital image. For instance, as previously described, the planar surface detection system 102 generates the segmentation mask 402 utilizing a segmentation neural network. In some embodiments, the planar surface detection system 102 generates a plurality of segmentation masks for a plurality of planar surfaces in a digital image, depending on the number of planar surfaces in the digital image.

In one or more embodiments, the planar surface detection system 102 generates a contour image 404 from the segmentation mask 402. In particular, the planar surface detection system 102 utilizes a contour detection algorithm that detects borders of objects in a digital image. For example, the planar surface detection system 102 utilizes a function that finds a curve that joins all continuous points along a boundary and contains the same color or intensity. Thus, the planar surface detection system 102 utilizes the contour detection algorithm to generate the contour image 404 by detecting a boundary along the outside of the planar surface indicated in the segmentation mask 402 and drawing the contour along the boundary in the contour image 404. In some embodiments, the planar surface detection system 102 also fills the drawn contour with a single color to create a solid shape representing an estimate of the planar surface.

Furthermore, as illustrated in FIG. 4, the planar surface detection system 102 generates an edge map 406 by detecting edges of the contour image 404. For example, the planar surface detection system 102 utilizes an edge detection algorithm (e.g., Canny edge detection or Sobel edge detection) to detect edges in the contour image 404. In one or more embodiments, the planar surface detection system 102 utilizes the edge detection algorithm to detect and highlight edges along a boundary in the contour image 404. The planar surface detection system 102 generates the edge map 406 including the detected edges.

In one or more embodiments, the planar surface detection system 102 also determines sets of lines corresponding to the edges. Specifically, the planar surface detection system 102 utilizes a line transform (e.g., a Hough transform) operation to detect straight lines in the edge map 406. As part of the line transform operation, the planar surface detection system 102 detects one or more lines for each of the edges in the edge map 406, resulting in straight line sets 408.

For example, the planar surface detection system 102 utilizes a Hough transform to detect lines by parameterizing lines in a polar coordinate space. For instance, the planar surface detection system 102 represents lines in the edge map 406 in the polar coordinate space via ρ=x cos θ+y sin θ, where ρ is the perpendicular distance from an origin to the line and θ is the angle of the perpendicular. The planar surface detection system 102 also utilizes an accumulator matrix to count the number of edge points that fall on each (ρ, θ) pair by plotting a sinusoidal curve in the polar coordinate space for each edge point (x, y). Furthermore, the planar surface detection system 102 utilizes the accumulator matrix to determine the most likely lines in the edge map 406. More specifically, the planar surface detection system 102 identifies the most likely lines as peaks in the accumulator matrix by finding cells with the highest votes (e.g., a number of points on the line, thus indicating the presence of a line).

In one or more embodiments, the planar surface detection system 102 performs a plurality of iterations of a Hough transform utilizing a plurality of different thresholds. In particular, the planar surface detection system 102 performs a first iteration utilizing a first threshold (e.g., a first minimum vote value) to find a first set of lines. Additionally, the planar surface detection system 102 performs a second iteration utilizing a second threshold (e.g., a second minimum vote value) to find a second set of lines. In some embodiments, the second set of lines includes the first set of lines and one or more additional lines based on a different minimum vote value. In response to iterating over a plurality of thresholds, the planar surface detection system 102 determines the straight line sets 408, each of which potentially includes at least one straight line and potentially more than one straight line.

In additional embodiments, as illustrated in FIG. 4, the planar surface detection system 102 determines filtered lines 410 based on the straight line sets 408. Specifically, the straight line sets 408 potentially include redundant or spurious lines based on imperfections in the edge map 406. Thus, the planar surface detection system 102 utilizes one or more filtering operations to refine the straight lines determined via the Hough transform. In one or more embodiments, the planar surface detection system 102 utilizes one or more filters to reduce the straight line sets to the most likely lines corresponding to an edge of a planar surface. FIG. 5 and the corresponding description provide additional detail with respect to filtering sets of straight lines.

In one or more embodiments, the planar surface detection system 102 utilizes the filtered lines 410 to determine candidate corner points 412 corresponding to possible corners of a planar surface. For instance, the planar surface detection system 102 predicts corners of the planar surface based on the filtered lines 410 by determining intersections of the filtered lines 410 (e.g., in the image space). Additionally, the planar surface detection system 102 validates the candidate corner points 412 and an area formed by the candidate corner points 412, as described in more detail with respect to FIG. 5.

In response to validating the candidate corner points 412, the planar surface detection system 102 determines corner coordinates 414. Specifically, the planar surface detection system 102 determines positions of the corners for inserting digital content into a digital image to fit within an area formed by the corners. For example, for a vector image, the planar surface detection system 102 determines the corner coordinates 414 as numerical values that define the positions of the corners within the image (e.g., along the x-axis and the y-axis) relative to the origin of the coordinate system. Alternatively, for a raster image, the planar surface detection system 102 determines the corner coordinates 414 as pixel coordinates in the raster image space.

FIG. 5 illustrates an example of the planar surface detection system 102 determining corners from a set of straight lines, as described in FIG. 4. For example, as illustrated, the planar surface detection system 102 determines straight line sets 502 corresponding to edges in an edge map. To illustrate, the planar surface detection system 102 determines the straight line sets 502 resulting from one or more Hough transform operations on the edge map.

Furthermore, as illustrated in FIG. 5, the planar surface detection system 102 filters the straight line sets 502 to determine the optimal straight lines representing an edge of a planar surface. In particular, the planar surface detection system 102 utilizes one or more filters to reduce the number of straight lines in the straight line sets 502. For example, the planar surface detection system 102 utilizes a distance filter 504 and an angle filter 506 to remove one or more lines in the straight line sets 502, resulting in filtered lines 508.

To illustrate, the planar surface detection system 102 utilizes the distance filter 504 to determine redundant lines that are too close to each other. For example, the planar surface detection system 102 calculates the Euclidean distance d between two lines as d=\sqrt{(x₂-x₁)²+(y₂-y₁)²}. The planar surface detection system 102 determines that lines with a distance less than a specified distance threshold are redundant and removes one of the lines.

The planar surface detection system 102 also utilizes the angle filter 506 to determine redundant lines with similar orientations. In particular, the planar surface detection system 102 calculates the angle difference Δθ between two lines as Δθ=|θ₁−θ₂|. The planar surface detection system 102 determines that lines with an angle difference less than a specified angle threshold are redundant and removes one of the lines. Thus, the planar surface detection system 102 removes redundant lines that are too close and/or have similar orientations, resulting in the filtered lines 508.

In one or more embodiments, the planar surface detection system 102 determines candidate corners from the filtered lines 508. For instance, the planar surface detection system 102 determines line intersections 510 for the filtered lines 508. At each of the line intersections 510, the planar surface detection system 102 determines a candidate corner. To illustrate, the planar surface detection system 102 determines an intersection point (x, y) of two filtered lines represented by a₁x+b₁y+c₁ and a₂x+b₂y+c₂ via:

$$\begin{matrix}x = \frac{{b}_{1} {c}_{2} - {b}_{2} {c}_{1}}{{a}_{1} {b}_{2} - {a}_{2} {b}_{1}} \\ y = \frac{{a}_{2} {c}_{1} - {a}_{1} {c}_{2}}{{a}_{1} {b}_{2} - {a}_{2} {b}_{1}}\end{matrix}$$

Furthermore, in one or more embodiments, the planar surface detection system 102 performs an initial validation step for the candidate corners at the line intersections 510. For example, the planar surface detection system 102 determines a shape 512 formed by the candidate corners. Additionally, the planar surface detection system 102 determines whether the shape 512 is a valid polygon (e.g., a quadrilateral such as a rectangle or parallelogram). More specifically, the planar surface detection system 102 determines checks the geometric arrangement of the candidate corners and determines that the geometric arrangement is valid for a planar surface. In additional embodiments, the planar surface detection system 102 sorts the corners in a consistent order (e.g., clockwise) for downstream operations that utilize ordering of points or line orientations.

In one or more embodiments, the planar surface detection system 102 also determines one or more metrics based on the shape 512 or a size of the area formed by the corners. In particular, as illustrated in FIG. 5, the planar surface detection system 102 generates an intersection-over-union metric (e.g., “IoU metric 516”) between an area formed by the corners (e.g., the shape 512) and an area corresponding to the planar surface in a segmentation mask 514. For example, the planar surface detection system 102 generates the IoU metric 516 to indicate an accuracy of the corners based on an overlap between the shape 512 and the segmentation mask 514. To illustrate, the planar surface detection system 102 generates the IoU metric 516 via:

$$IoU = \frac{{A}_{p} ⋂ {A}_{g}}{{A}_{p} ⋃ {A}_{g}}$$

in which Aₚ is the area within the corners and A_{g} is the area of the planar surface in the segmentation mask 514.

In one or more embodiments, the planar surface detection system 102 determines whether the overlap between the shape 512 and the segmentation mask 514 is acceptable via a threshold IoU metric 518. Specifically, the planar surface detection system 102 utilizes the threshold IoU metric 518 to perform an additional validation check based on the percentage of overlap between the shape 512 and the segmentation mask 514. To illustrate, the planar surface detection system 102 utilizes a threshold IoU metric 518 indicating a threshold ratio (e.g., 0.90 or 0.95). In response to determining that the IoU metric 516 is at least the threshold IoU metric 518, the planar surface detection system 102 determines that the corners are valid.

In response to validating the corners by verifying the shape and the intersection-over-union relative to the segmentation mask 514, the planar surface detection system 102 determines corner coordinates 520. Thus, as previously mentioned, the planar surface detection system 102 determines coordinates for each of the corners of the planar surface in a respective image space. As described in more detail below, the planar surface detection system 102 utilizes the corner coordinates 520 to perform a transformation on a digital asset inserted into the digital image.

FIG. 6 illustrates a diagram of a process in which the planar surface detection system 102 applies a perspective transformation to a digital asset. In one or more embodiments, the planar surface detection system 102 determines corner coordinates 602 corresponding to a planar surface (e.g., utilizing a segmentation neural network with a corner detection algorithm). More specifically, the planar surface detection system 102 determines corner coordinates 602 at corners of the detected planar surface, in which the corner coordinates 602 define the vertices of the planar surface. Additionally, in one or more embodiments, the planar surface detection system 102 determines digital asset corners 604 of a digital asset. For instance, the planar surface detection system 102 determines a size, shape, and/or resolution of the digital asset to determine the digital asset corners 604.

According to one or more embodiments, the planar surface detection system 102 generates a transformation matrix 606 for modifying the digital asset and insert the digital asset into the digital image at a location of the planar surface. For example, the planar surface detection system 102 utilizes the transformation matrix 606 to ensure that the digital asset is accurately placed on the planar surface within the area defined by the corner coordinates 602. In particular, the planar surface detection system 102 generates the transformation matrix 606 for transforming a perspective of the digital asset. In one or more embodiments, the planar surface detection system 102 generates the transformation matrix 606 from the digital asset corners 604 as source coordinates and the corner coordinates 602 as destination coordinates. For example, the planar surface detection system 102 generates a homography matrix as:

$$s [ \begin{matrix}{x}^{′} \\ {y}^{′} \\ 1\end{matrix} ] = H [ \begin{matrix}x \\ y \\ 1\end{matrix} ]$$

where (x, y) are the source coordinates, (x′, y′) are the destination coordinates, and s is a scale factor.

Furthermore, in response to generating the transformation matrix 606, the planar surface detection system 102 provides the transformation matrix to a perspective transformation function 608. In some embodiments, the perspective transformation function 608 is part of a digital image application 610. To illustrate, the planar surface detection system 102 accesses the perspective transformation function 608 from the digital image application 610 to modify a perspective of the digital asset (e.g., by changing the boundaries). As an example, the planar surface detection system 102 accesses the perspective transformation function 608 directly from the digital image application 610 (e.g., in scenarios in which the planar surface detection system 102 has access to all functions of the digital image application 610). Alternatively, the planar surface detection system 102 causes the digital image application 610 to execute the perspective transformation function 608 via an application programming interface call to the digital image application 610. The planar surface detection system 102 thus executes (or causes a computing device to execute) the perspective transformation function 608 to generate a modified digital asset 612 including the digital asset transformed to fit in the area defined by the corner coordinates 602 by modifying each pixel of the digital asset according to the transformation matrix 606.

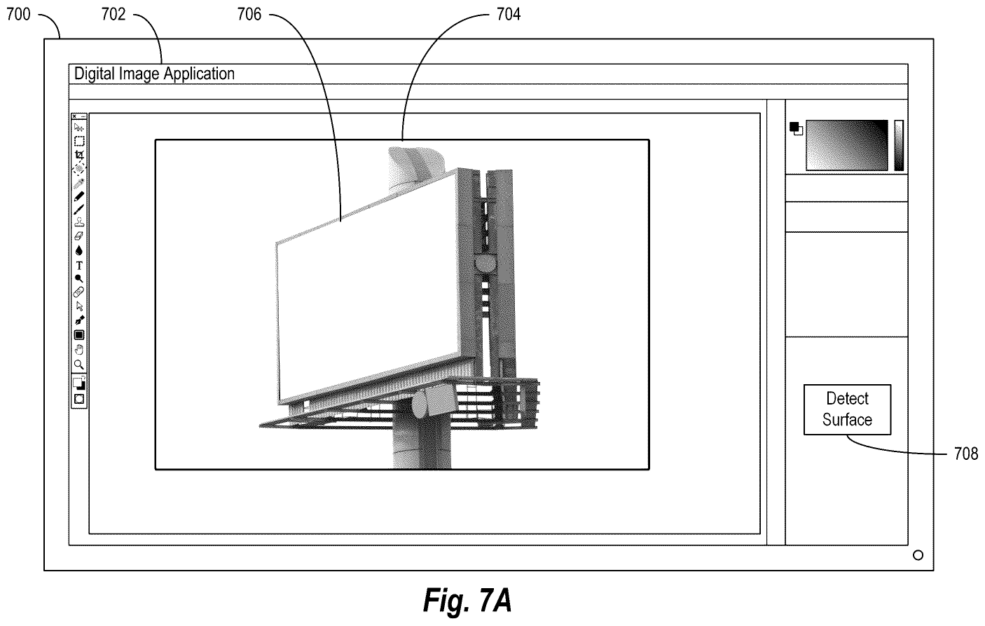

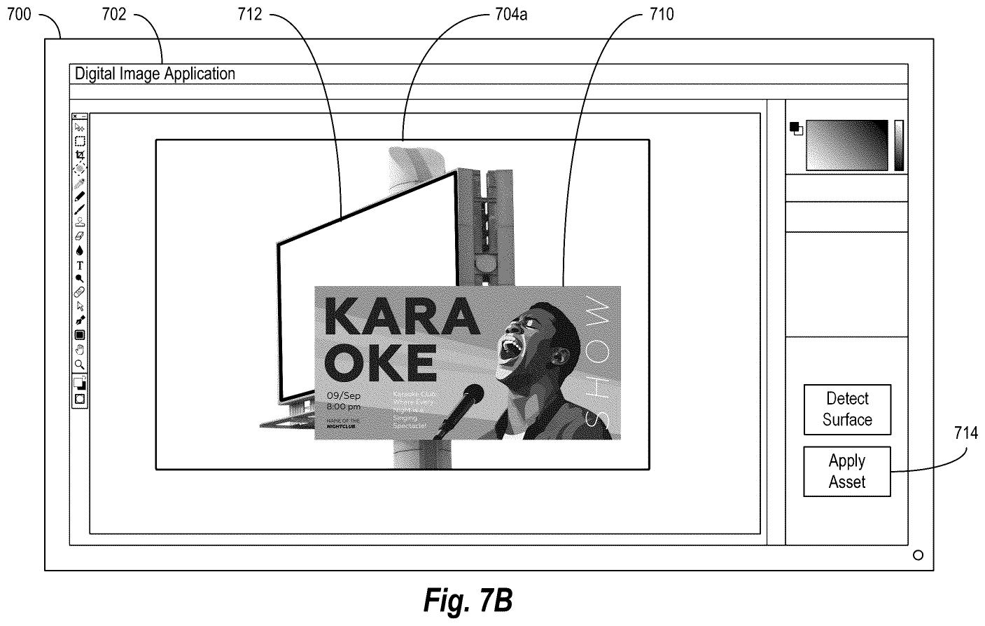

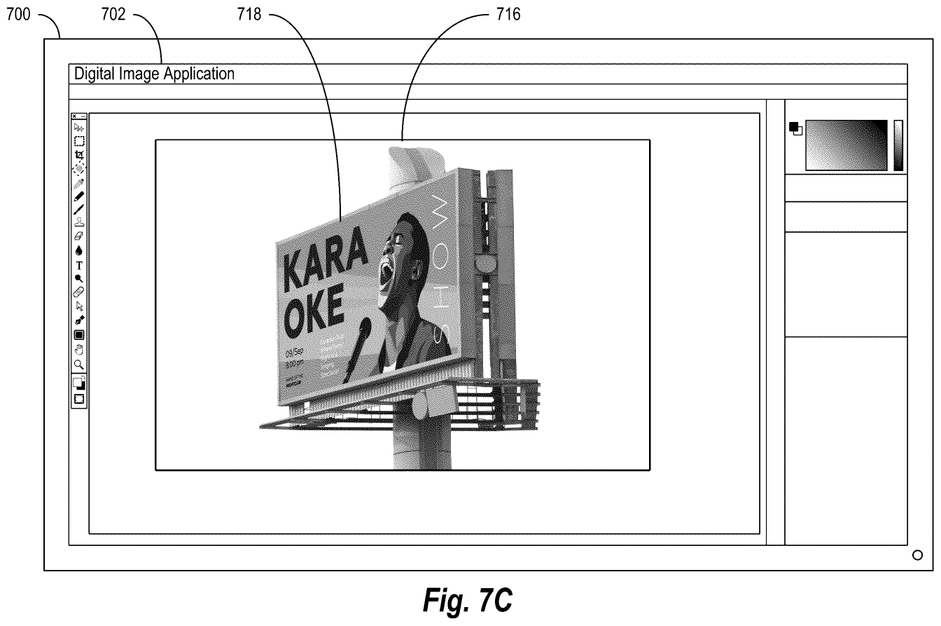

In one or more embodiments, the planar surface detection system 102 provides indications of detected planar surfaces and modified digital assets in graphical user interfaces. FIGS. 7A-7C illustrate graphical user interfaces for modifying a digital image via detection of a planar surface and insertion of a digital asset into the digital image on the planar surface. Specifically, as illustrated in FIG. 7A, a client device 700 includes a graphical user interface 702 of a digital image application for editing digital images. For example, the digital image application includes a vector editing application or a raster editing application. Accordingly, the client device 700 displays a digital image 704 including digital image content for editing utilizing the digital image application.

As illustrated, digital image 704 includes a planar surface 706, such as a flat surface on an object in the digital image 704. According to some embodiments, the planar surface detection system 102 utilizes a segmentation neural network to detect the planar surface 706 in response to a request to detect one or more planar surfaces or a request to insert a digital asset on a surface of the digital image. For instance, the planar surface detection system 102 detects the planar surface 706 in response to a selection of a detect surface element 708 displayed in the graphical user interface 702. In additional embodiments, the planar surface detection system 102 detects planar surfaces in the digital image 704 in response to loading and displaying the digital image 704 (e.g., in one or more initial processing steps) for quicker response to a request to detect planar surfaces.

In one or more embodiments, the planar surface detection system 102 provides visual indications of detected planar surfaces in a digital image. FIG. 7B illustrates an example of the client device 700 displaying information in the graphical user interface 702 in connection with inserting a digital asset 710 on a planar surface. More specifically, in response to detecting a planar surface, in one or more embodiments, the planar surface detection system 102 generates a highlight 712 indicating a boundary of the planar surface for displaying within the graphical user interface 702 on the digital image 704a. In some embodiments, the highlight 712 includes a visible outline of the planar surface. In additional embodiments, the highlight 712 includes a visible highlight of the entire area of the planar surface.

In one or more embodiments, the planar surface detection system 102 generates and displays the highlight 712 in response to a request to detect the planar surface, such as via a selection of an asset application element 714. Alternatively, the planar surface detection system 102 generates and displays the highlight 712 in response to a selection of a digital asset 710. In additional embodiments, the planar surface detection system 102 does not display the highlight 712 and automatically inserts the digital asset 710 on the planar surface in response to a selection of the digital asset 710 with an operation to detect the planar surface.

FIG. 7C illustrates an example of the client device 700 displaying a modified digital image 716. In particular, the planar surface detection system 102 modifies the digital image 704a of FIG. 7B to insert the digital asset 710 on the planar surface. As described above, the planar surface detection system 102 executes a perspective transportation function to modify the perspective and position of the digital asset 710 utilizing a transformation matrix based on corners of the planar surface. Thus, as illustrated in FIG. 7C, the modified digital image 716 includes a modified digital asset 718 with a transformed perspective and positioned on the planar surface.

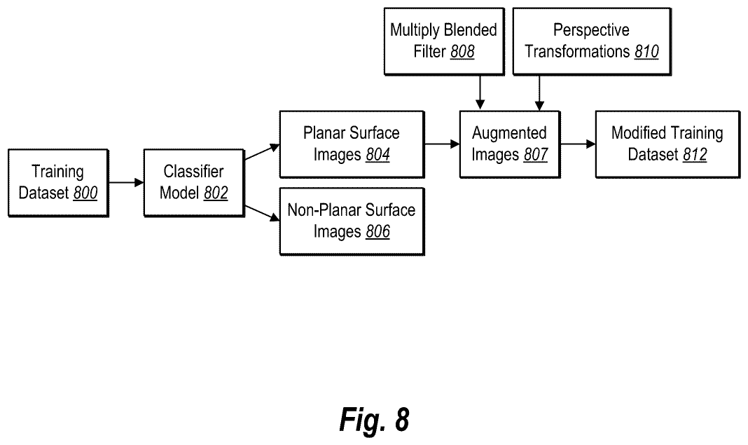

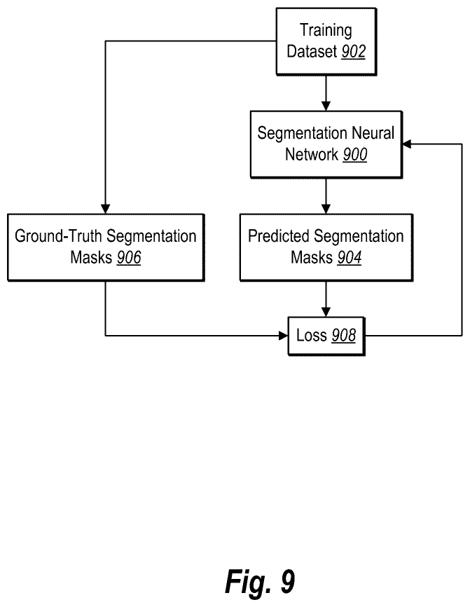

In one or more embodiments, the planar surface detection system 102 generates and utilizes training data to train a segmentation neural network to detect planar surfaces. FIG. 8 illustrates a diagram of the planar surface detection system 102 generating training data for use in training a segmentation neural network. FIG. 9 illustrates a diagram of the planar surface detection system 102 utilizing generated training data to train a segmentation neural network to detect planar surfaces in digital images.

As illustrated in FIG. 8, the planar surface detection system 102 determines a training dataset 800 including a plurality of digital images. In one or more embodiments, the training dataset 800 includes digital images with specific visual attributes. For example, the planar surface detection system 102 includes mockup images for generating representations of prototypes, products, or concepts for creating proof of concepts. Thus, in some embodiments, the mockup images include digitally inserted surfaces on one or more objects, including digitally inserted planes on planar surfaces in some of the digital images. Furthermore, in some embodiments, the specific visual attributes include prominent foreground objects or specific types of objects relevant to mockup images. Additionally, in some embodiments, the specific visual attributes include specific color or lightness schemes or attributes relevant to mockup images.

Furthermore, in one or more embodiments, the planar surface detection system 102 utilizes a classifier model 802 to classify the training dataset 800. For example, the classifier model 802 includes a first classifier (e.g., a first neural network layer) that classifies planar surface images 804 and a second classifier (e.g., a second neural network layer) that classifies non-planar surface images 806. More specifically, the planar surface detection system 102 utilizes the classifier model 802 to detect digital images in the training dataset 800 that include planar surfaces and digital images in the training dataset 800 that do not include planar surfaces.

In one or more embodiments, the planar surface detection system 102 trains the classifier model 802 utilizing a subset of the training dataset 800. In particular, the planar surface detection system 102 determines the subset of the training dataset 800 by selecting a balanced dataset containing digital images of planar and non-planar surfaces. The planar surface detection system 102 thus utilizes the subset of the training dataset 800 to train the classifier model 802 to recognize planar and non-planar surfaces in digital images for accurately detecting the planar surface images 804 in the training dataset 800. In one or more additional embodiments, the planar surface detection system 102 annotates the planar surface images 804 to mark planar surfaces.

Additionally, in one or more embodiments, the planar surface detection system 102 filters the training dataset 800 based on a confidence threshold for the classifier model 802. For instance, the planar surface detection system 102 generates predictions of classifications for each of the digital images in the training dataset 800 and compares confidence scores of the predictions to the confidence threshold (e.g., 80%). In response to determining that confidence scores of the predictions for a set of digital images meet the confidence threshold, the planar surface detection system 102 selects the set of digital images for further processing. To illustrate, the planar surface detection system 102 selects the planar surface images 804 for additional processing in response to determining that the confidence scores associated with the planar surface images 804 meet the confidence threshold.

As illustrated, in one or more embodiments, the planar surface detection system 102 augments the training dataset 800 by generating augmented images 807 based on the planar surface images 804. For example, in some embodiments, the planar surface detection system 102 utilize one or more filters or image modifiers to augment the planar surface images 804. To illustrate, the planar surface detection system 102 utilizes a multiply blending filter 808 to apply shadow effects to the planar surface images 804. In additional examples, the planar surface detection system 102 utilizes perspective transformations 810 to apply different perspectives to the planar surface images 804. Thus, the planar surface detection system 102 generates a modified training dataset 812 that captures a wide range of scenarios for improving the accuracy and performance of a segmentation neural network.

FIG. 9 illustrates a process of the planar surface detection system 102 training a segmentation neural network 900. In particular, as illustrated, the planar surface detection system 102 utilizes a training dataset 902 that includes a plurality of digital images with planar surface. For example, the planar surface detection system 102 utilizes the training dataset of FIG. 8 to train the segmentation neural network 900. In one or more embodiments, the planar surface detection system 102 utilizes the segmentation neural network 900 to generate predicted segmentation masks 904 for planar surfaces in digital images of the training dataset 902.

Additionally, the planar surface detection system 102 determines ground-truth segmentation masks 906 for the digital images in the training dataset 902. For example, as previously mentioned, the planar surface detection system 102 annotates the digital images in the training dataset 902 to mark the planar surfaces. Accordingly, the planar surface detection system 102 utilizes the annotations for the ground-truth segmentation masks 906.

In one or more embodiments, the planar surface detection system 102 compares the predicted segmentation masks 904 to the ground-truth segmentation masks 906 to determine a loss 908. For instance, the planar surface detection system utilizes a loss function to determine the loss 908 based on differences between the predicted segmentation masks 904 and the ground-truth segmentation masks 906. To illustrate, the planar surface detection system 102 utilizes a Dice loss function to determine the loss 908. In other embodiments, the planar surface detection system 102 utilizes another loss function such as a cross entropy loss function or a combination of loss functions to determine the loss 908.

In response to determining the loss 908, the planar surface detection system 102 utilizes the loss 908 to train the segmentation neural network 900. In particular, the planar surface detection system 102 utilizes the loss 908 to adjust parameters of the segmentation neural network 900 to reduce the differences between the predicted segmentation masks 904 and the ground-truth segmentation masks 906. For instance, the planar surface detection system 102 utilizes an Adam optimizer in combination with a StepLR scheduler to generate a trained segmentation neural network by dynamically adjusting the learning rate for optimal convergence during training.

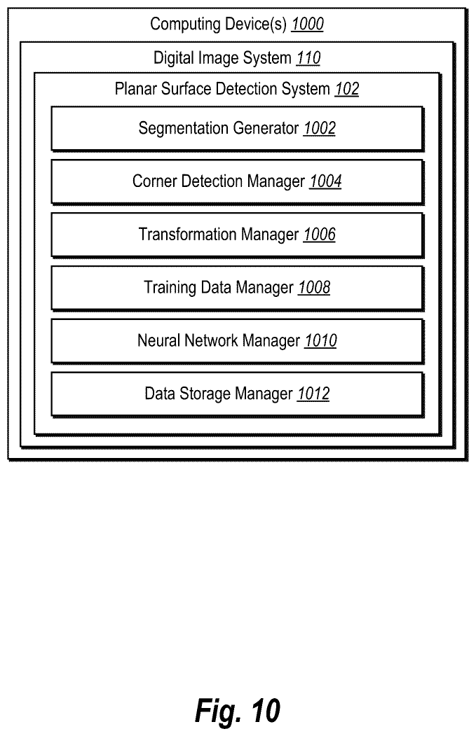

FIG. 10 illustrates a detailed schematic diagram of an embodiment of the planar surface detection system 102 described above. As shown, the planar surface detection system 102 is implemented in a digital image system 110 on computing device(s) 1000 (e.g., a client device and/or server device as described in FIG. 1, and as further described below in relation to FIG. 12). Additionally, the planar surface detection system 102 includes, but is not limited to, a segmentation generator 1002, a corner detection manager 1004, a transformation manager 1006, a training data manager 1008, a neural network manager 1010, and a data storage manager 1012. In one or more embodiments, the planar surface detection system 102 is implemented on any number of computing devices. For example, the planar surface detection system 102, in one or more embodiments, is implemented in a distributed system of server devices for digital image processing. Alternatively, the planar surface detection system 102 is also implemented within one or more additional systems. For example, the planar surface detection system 102, in one or more embodiments, is implemented on a single computing device such as a single client device.

In one or more embodiments, each of the components of the planar surface detection system 102 is in communication with other components using any suitable communication technologies. Additionally, the components of the planar surface detection system 102 are capable of being in communication with one or more other devices including other computing devices of a user, server devices (e.g., cloud storage devices), licensing servers, or other devices/systems. It will be recognized that although the components of the planar surface detection system 102 are shown to be separate in FIG. 10, any of the subcomponents may be combined into fewer components, such as into a single component, or divided into more components as may serve a particular implementation. Furthermore, although the components of FIG. 10 are described in connection with the planar surface detection system 102, at least some of the components for performing operations in conjunction with the planar surface detection system 102 described herein are implemented on other devices within the environment in other embodiments.

In some embodiments, the components of the planar surface detection system 102 include software, hardware, or both. For example, the components of the planar surface detection system 102 include one or more instructions stored on a computer-readable storage medium and executable by processors of one or more computing devices (e.g., the computing device(s) 1000). When executed by the one or more processors, the computer-executable instructions of the planar surface detection system 102 cause the computing device(s) 1000 to perform the operations described herein. Alternatively, the components of the planar surface detection system 102 include hardware, such as a special purpose processing device to perform a certain function or group of functions. Additionally, or alternatively, the components of the planar surface detection system 102 include a combination of computer-executable instructions and hardware.

Furthermore, the components of the planar surface detection system 102 performing the functions described herein with respect to the planar surface detection system 102 may, for example, be implemented as part of a stand-alone application, as a module of an application, as a plug-in for applications, as a library function or functions that may be called by other applications, and/or as a cloud-computing model. Thus, the components of the planar surface detection system 102 may be implemented as part of a stand-alone application on a personal computing device or a mobile device. Alternatively, or additionally, the components of the planar surface detection system 102 may be implemented in any application that provides digital image editing, including, but not limited to ADOBE® PHOTOSHOP®, ADOBE® ILLUSTRATOR®, and ADOBE® CREATIVE CLOUD® software.

As illustrated, the planar surface detection system 102 includes a segmentation generator 1002 to generate and manage segmentations of digital images. In particular, the segmentation generator 1002 utilizes a segmentation neural network to generate segmentation masks of planar surfaces of digital images. In some embodiments, the segmentation generator 1002 generates segmentation masks in connection with image editing tasks, such as requests to insert digital assets into digital images.

In one or more embodiments, the planar surface detection system 102 includes a corner detection manager 1004 to detect corners of planar surfaces in digital images. For example, the corner detection manager 1004 utilizes a corner detection algorithm to detect corners of a planar surface, e.g., by obtaining a segmentation mask generated by the segmentation generator 1002 and performing corner detection on the segmentation mask.

According to one or more embodiments, the planar surface detection system 102 includes a transformation manager 1006 that transforms digital assets for insertion on planar surfaces of digital images. For instance, the transformation manager 1006 modifies a digital asset utilizing corners detected by the corner detection manager 1004. Specifically, the transformation manager 1006 generates a transformation matrix and utilizes the transformation matrix to execute a perspective transformation function on the digital asset.

The planar surface detection system 102 also includes a training data manager 1008 to generate training data for use in training one or more neural networks. For example, the training data manager 1008 generates training data including digital images with planar surfaces for training a segmentation neural network. To illustrate, the training data manager 1008 utilizes a classifier model to classify digital images including planar surfaces. Additionally, the training data manager 1008 augments training data by applying various filters and/or transformations to digital images.

The planar surface detection system 102 further includes a neural network manager 1010 to train one or more neural networks. For example, the neural network manager 1010 utilizes a training dataset to train a segmentation neural network. Additionally, in some embodiments, the neural network manager 1010 trains a classifier model for use in generating a training dataset for training the segmentation neural network.

The planar surface detection system 102 also includes a data storage manager 1012 (that comprises a non-transitory computer memory) that stores and maintains data associated with detecting planar surfaces in digital images and editing digital images. For example, the data storage manager 1012 stores segmentation masks, digital assets, corner coordinates, and transformation matrices. Additionally, the data storage manager 1012 stores data associated with generating and utilizing training data to train neural networks, including digital images classified as planar surface images, predicted segmentation masks, and ground-truth segmentation masks.

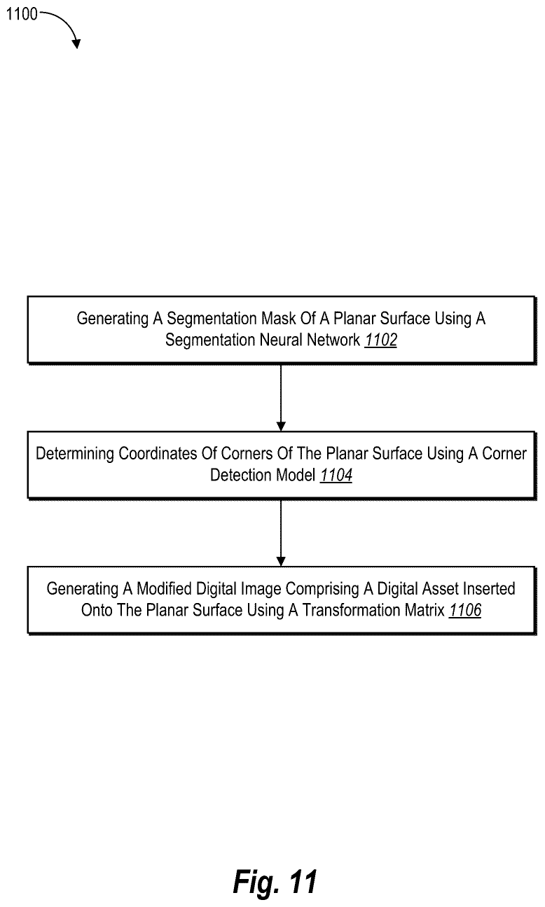

Turning now to FIG. 11, this figure shows a flowchart of a series of acts 1100 of inserting a digital asset on a planar surface in a digital image utilizing a segmentation neural network and corner detection. While FIG. 11 illustrates acts according to one embodiment, alternative embodiments may omit, add to, reorder, and/or modify any of the acts shown in FIG. 11. The acts of FIG. 11 are part of a method. Alternatively, a non-transitory computer readable medium comprises instructions, that when executed by one or more processors, cause the one or more processors to perform the acts of FIG. 11. In still further embodiments, a system includes a processor or server configured to perform the acts of FIG. 11.

As shown, the series of acts 1100 includes an act 1102 of generating a segmentation mask of a planar surface using a segmentation neural network. The series of acts 1100 also includes an act 1104 of determining coordinates of corners of the planar surface using a corner detection model. The series of acts 1100 further includes an act 1106 of generating a modified digital image comprising a digital asset inserted onto the planar surface using a transformation matrix.

In one or more embodiments, act 1102 involves generating, utilizing a segmentation neural network, a segmentation mask of a planar surface in a digital image. Act 1104 involves determining, utilizing a corner detection model, coordinates of corners of the planar surface from an outer contour extracted from the segmentation mask. Additionally, act 1106 involves generating, for display via a graphical user interface displaying the digital image, a modified digital image comprising a digital asset inserted onto the planar surface by performing a perspective transformation on the digital asset utilizing a transformation matrix determined from the coordinates of the corners of the planar surface.

In additional embodiments, the series of acts 1100 includes determining the coordinates of the corners of the planar surface by generating a contour image by extracting the outer contour from the segmentation mask, and filling, in the contour image, an interior area defined by the outer contour with a solid fill color. Additionally, the series of acts 1100 includes generating an edge map by detecting a plurality of edges in the contour image utilizing an edge detection algorithm. The series of acts 1100 also includes determining, from the edge map, sets of one or more straight lines along the outer contour from the plurality of edges by utilizing a Hough transform to generate representations of the plurality of edges in a polar coordinate system utilizing pairs of polar coordinates. The series of acts 1100 also utilizes the Hough transform to determine the sets of one or more straight lines along the outer contour by counting a number of edge points of the plurality of edges that fall on each pair of polar coordinates and iterating over a plurality of threshold intersection values.

In some embodiments, the series of acts 1100 includes filtering the sets of one or more straight lines by comparing distances between pairs of lines of the sets of one or more straight lines to a distance threshold. The series of acts 1100 further includes filtering the sets of one or more straight lines by comparing angles between the pairs of lines of the sets of one or more straight lines to an angle threshold.

In one or more embodiments, the series of acts 1100 includes determining a filtered set of straight lines from a plurality of edges in a contour image extracted from the segmentation mask. The series of acts 1100 also includes determining intersections of the filtered set of straight lines as candidate corner points. The series of acts 1100 further includes verifying that a shape formed by the candidate corner points form a valid polygon.

In some embodiments, the series of acts 1100 includes generating an intersection-over-union metric between the segmentation mask and a shape formed by candidate corner points of the planar surface. The series of acts 1100 also includes determining the coordinates of the corners of the planar surface from the candidate corner points in response to determining that the intersection-over-union metric is at least a threshold intersection-over-union value.

In one or more embodiments, the series of acts 1100 includes determining a training dataset comprising a plurality of filtered digital images with a specified set of visual attributes. The series of acts 1100 further includes generating a modified training dataset by filtering the training dataset to a subset of digital images of the plurality of filtered digital images classified as comprising planar surfaces by a classifier model. The series of acts 1100 also includes training the segmentation neural network using the training dataset to generate segmentation masks for planar surfaces in digital images.

In additional embodiments, the series of acts 1100 includes determining a subset of filtered digital images of the training dataset comprising a first set of digital images with planar surfaces and a second set of digital images without planar surfaces. The series of acts 1100 also includes training the classifier model utilizing the subset of filtered digital images of the training dataset to classify digital images including planar surfaces.

In one or more embodiments, the series of acts 1100 includes generating, utilizing the classifier model, a plurality of predicted classifications for the plurality of filtered digital images in the training dataset indicating whether the plurality of filtered digital images include planar surfaces. The series of acts 1100 further includes filtering the training dataset to the subset of digital images in response to determining that classification confidence scores of predicted classifications for the subset of digital images of the plurality of filtered digital images meets a confidence threshold.

In one or more embodiments, the series of acts 1100 includes receiving a training dataset comprising a plurality of filtered digital images with a specified set of visual attributes. The series of acts 1100 further includes classifying, utilizing a classifier model, the plurality of filtered digital images to indicate whether the plurality of filtered digital images comprise planar surfaces. The series of acts 1100 also includes generating a modified training dataset by filtering the training dataset to a subset of digital images of the plurality of filtered digital images classified as comprising planar surfaces. The series of acts 1100 also includes training a segmentation neural network using the modified training dataset to generate a trained segmentation neural network that generates segmentation masks for planar surfaces in digital images.

In one or more embodiments, the series of acts 1100 includes determining a subset of digital images of the plurality of filtered digital images comprising a first set of digital images with planar surfaces and a second set of digital images without planar surfaces. The series of acts 1100 also includes training the classifier model to classify the first set of digital images as planar surface images and the second set of digital images as non-planar surface images.

In additional embodiments, the series of acts 1100 includes generating, utilizing the classifier model, a plurality of predicted classifications for the plurality of filtered digital images in the training dataset as planar surface images or non-planar surfaces. The series of acts 1100 also includes filtering the training dataset to the subset of digital images comprising planar surface images in response to determining that classification confidence scores of predicted classifications for the subset of digital images of the plurality of filtered digital images meets a confidence threshold.

In some embodiments, the series of acts 1100 includes annotating the subset of digital images to mark the planar surfaces. The series of acts 1100 also includes generating, for the modified training dataset, modified digital images by augmenting the subset of digital images with a multiply blending filter or perspective transformation modifications to modify the planar surfaces in the subset of digital images.

According to one or more embodiments, the series of acts 1100 includes generating, utilizing the trained segmentation neural network, a segmentation mask of a planar surface in a digital image. The series of acts 1100 further includes determining coordinates of corners of the planar surface, and generating a modified digital image comprising a digital asset inserted onto the planar surface by utilizing a transformation matrix to perform a perspective transformation on the digital asset according to the coordinates of the corners.

The series of acts 1100 also includes generating a contour image comprising an outer contour from the segmentation mask with a solid fill color inside the outer contour. The series of acts 1100 further includes generating, utilizing an edge detection algorithm, an edge map by detecting a plurality of edges in the contour image. Additionally, the series of acts 1100 includes determining a plurality of straight lines along the outer contour from the plurality of edges in the edge map. The series of acts 1100 also includes determining the coordinates of the corners from intersections of the plurality of straight lines.

The series of acts 1100 also includes determining candidate corner points from the intersections of the plurality of straight lines. The series of acts 1100 includes determining a shape formed by the candidate corner points. Furthermore, the series of acts 1100 includes generating an intersection-over-union metric between the segmentation mask and the shape formed by the candidate corner points. Additionally, the series of acts 1100 includes determining the coordinates of the corners in response to determining that the intersection-over-union metric is at least a threshold intersection-over-union value.

In one or more embodiments, the series of acts 1100 includes generating, utilizing a segmentation neural network, a segmentation mask for a planar surface in a digital image. The series of acts 1100 further includes determining, utilizing a corner detection model, coordinates of corners of the planar surface from an outer contour extracted from the segmentation mask. The series of acts 1100 also includes generating, for display via a graphical user interface displaying the digital image, a modified digital image comprising a digital asset inserted onto the planar surface by performing a perspective transformation on the digital asset utilizing a transformation matrix determined from the coordinates of the corners of the planar surface.

In one or more embodiments, the series of acts 1100 includes detecting a plurality of edges of the outer contour utilizing an edge detection algorithm. The series of acts 1100 also includes determining sets of one or more straight lines along the outer contour from the plurality of edges utilizing a Hough transform with a plurality of threshold intersection values. The series of acts 1100 further includes determining a filtered set of straight lines from the sets of one or more straight lines according to a distance threshold and an angle threshold. Additionally, the series of acts 1100 includes determining the coordinates of the corners from intersections of the filtered set of straight lines.

In some embodiments, the series of acts 1100 includes generating a transformation matrix from source points corresponding to corners of the digital asset to destination points corresponding to the coordinates of the corners of the planar surface. The series of acts 1100 further includes executing a function to perform the perspective transformation on the digital asset by applying the transformation matrix to a plurality of pixels of the digital asset.

In one or more embodiments, the series of acts 1100 includes generating a training dataset comprising a plurality of modified digital images by classifying, utilizing a classifier model, a plurality of digital images as planar surface images or non-planar surface images, and generating the plurality of modified digital images by augmenting the planar surface images utilizing a multiply blending filter or a perspective transformation. The series of acts 1100 also includes training, utilizing the training dataset, the segmentation neural network to detect planar surfaces in digital images.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 12 illustrates a block diagram of exemplary computing device 1200 that may be configured to perform one or more of the processes described above. One will appreciate that one or more computing devices such as the computing device 1200 may implement the system(s) of FIG. 1. As shown by FIG. 12, the computing device 1200 can comprise a processor 1202, a memory 1204, a storage device 1206, an I/O interface 1208, and a communication interface 1210, which may be communicatively coupled by way of a communication infrastructure 1212. In certain embodiments, the computing device 1200 can include fewer or more components than those shown in FIG. 12. Components of the computing device 1200 shown in FIG. 12 will now be described in additional detail.

In one or more embodiments, the processor 1202 includes hardware for executing instructions, such as those making up a computer program. As an example, and not by way of limitation, to execute instructions for dynamically modifying workflows, the processor 1202 may retrieve (or fetch) the instructions from an internal register, an internal cache, the memory 1204, or the storage device 1206 and decode and execute them. The memory 1204 may be a volatile or non-volatile memory used for storing data, metadata, and programs for execution by the processor(s). The storage device 1206 includes storage, such as a hard disk, flash disk drive, or other digital storage device, for storing data or instructions for performing the methods described herein.

The I/O interface 1208 allows a user to provide input to, receive output from, and otherwise transfer data to and receive data from computing device 1200. The I/O interface 1208 may include a mouse, a keypad or a keyboard, a touch screen, a camera, an optical scanner, network interface, modem, other known I/O devices or a combination of such I/O interfaces. The I/O interface 1208 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 1208 is configured to provide graphical data to a display for presentation to a user. The graphical data may be representative of one or more graphical user interfaces and/or any other graphical content as may serve a particular implementation.

The communication interface 1210 can include hardware, software, or both. In any event, the communication interface 1210 can provide one or more interfaces for communication (such as, for example, packet-based communication) between the computing device 1200 and one or more other computing devices or networks. As an example, and not by way of limitation, the communication interface 1210 may include a network interface controller (NIC) or network adapter for communicating with an Ethernet or other wire-based network or a wireless NIC (WNIC) or wireless adapter for communicating with a wireless network, such as a WI-FI.

Additionally, the communication interface 1210 may facilitate communications with various types of wired or wireless networks. The communication interface 1210 may also facilitate communications using various communication protocols. The communication infrastructure 1212 may also include hardware, software, or both that couples components of the computing device 1200 to each other. For example, the communication interface 1210 may use one or more networks and/or protocols to enable a plurality of computing devices connected by a particular infrastructure to communicate with each other to perform one or more aspects of the processes described herein. To illustrate, the digital content campaign management process can allow a plurality of devices (e.g., a client device and server devices) to exchange information using various communication networks and protocols for sharing information such as electronic messages, user interaction information, engagement metrics, or campaign management resources.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A method comprising:
generating, by at least one processing device utilizing a segmentation neural network, a segmentation mask of a planar surface in a digital image;
determining, by the at least one processing device utilizing a corner detection model, coordinates of corners of the planar surface from an outer contour extracted from the segmentation mask; and
generating, by the at least one processing device and for display via a graphical user interface displaying the digital image, a modified digital image comprising a digital asset inserted onto the planar surface by performing a perspective transformation on the digital asset utilizing a transformation matrix determined from the coordinates of the corners of the planar surface.

2. The method of claim 1, wherein determining the coordinates of the corners of the planar surface comprises:
generating a contour image by extracting the outer contour from the segmentation mask; and
filling, in the contour image, an interior area defined by the outer contour with a solid fill color.

3. The method of claim 2, wherein determining the coordinates of the corners of the planar surface comprises:
generating an edge map by detecting a plurality of edges in the contour image utilizing an edge detection algorithm; and
determining, from the edge map, sets of one or more straight lines along the outer contour from the plurality of edges by utilizing a Hough transform to:
generate representations of the plurality of edges in a polar coordinate system utilizing pairs of polar coordinates; and
determine the sets of one or more straight lines along the outer contour by counting a number of edge points of the plurality of edges that fall on each pair of polar coordinates and iterating over a plurality of threshold intersection values.

4. The method of claim 3, wherein determining the coordinates of the corners of the planar surface comprises:
filtering the sets of one or more straight lines by comparing distances between pairs of lines of the sets of one or more straight lines to a distance threshold; and
filtering the sets of one or more straight lines by comparing angles between the pairs of lines of the sets of one or more straight lines to an angle threshold.

5. The method of claim 1, wherein determining the coordinates of the corners of the planar surface comprises:
determining a filtered set of straight lines from a plurality of edges in a contour image extracted from the segmentation mask;
determining intersections of the filtered set of straight lines as candidate corner points; and
verifying that a shape formed by the candidate corner points form a valid polygon.

6. The method of claim 1, wherein determining the coordinates of the corners of the planar surface comprises:
generating an intersection-over-union metric between the segmentation mask and a shape formed by candidate corner points of the planar surface; and
determining the coordinates of the corners of the planar surface from the candidate corner points in response to determining that the intersection-over-union metric is at least a threshold intersection-over-union value.

7. The method of claim 1, further comprising:
determining a training dataset comprising a plurality of filtered digital images with a specified set of visual attributes;
generating a modified training dataset by filtering the training dataset to a subset of digital images of the plurality of filtered digital images classified as comprising planar surfaces by a classifier model; and
training the segmentation neural network using the training dataset to generate segmentation masks for planar surfaces in digital images.

8. The method of claim 7, further comprising:
determining a subset of filtered digital images of the training dataset comprising a first set of digital images with planar surfaces and a second set of digital images without planar surfaces; and
training the classifier model utilizing the subset of filtered digital images of the training dataset to classify digital images including planar surfaces.

9. The method of claim 8, wherein generating the modified training dataset comprises:
generating, utilizing the classifier model, a plurality of predicted classifications for the plurality of filtered digital images in the training dataset indicating whether the plurality of filtered digital images include planar surfaces; and
filtering the training dataset to the subset of digital images in response to determining that classification confidence scores of predicted classifications for the subset of digital images of the plurality of filtered digital images meets a confidence threshold.

10. A method comprising:
receiving a training dataset comprising a plurality of filtered digital images with a specified set of visual attributes;
classifying, utilizing a classifier model, the plurality of filtered digital images to indicate whether the plurality of filtered digital images comprise planar surfaces;
generating a modified training dataset by filtering the training dataset to a subset of digital images of the plurality of filtered digital images classified as comprising planar surfaces; and
training a segmentation neural network using the modified training dataset to generate a trained segmentation neural network that generates segmentation masks for planar surfaces in digital images.

11. The method of claim 10, further comprising:
determining a subset of digital images of the plurality of filtered digital images comprising a first set of digital images with planar surfaces and a second set of digital images without planar surfaces; and
training the classifier model to classify the first set of digital images as planar surface images and the second set of digital images as non-planar surface images.

12. The method of claim 10, wherein classifying the plurality of filtered digital images comprises:
generating, utilizing the classifier model, a plurality of predicted classifications for the plurality of filtered digital images in the training dataset as planar surface images or non-planar surfaces; and
filtering the training dataset to the subset of digital images comprising planar surface images in response to determining that classification confidence scores of predicted classifications for the subset of digital images of the plurality of filtered digital images meets a confidence threshold.

13. The method of claim 10, wherein generating the modified training dataset comprises:
annotating the subset of digital images to mark the planar surfaces; and
generating, for the modified training dataset, modified digital images by augmenting the subset of digital images with a multiply blending filter or perspective transformation modifications to modify the planar surfaces in the subset of digital images.

14. The method of claim 10, further comprising:
generating, utilizing the trained segmentation neural network, a segmentation mask of a planar surface in a digital image;
determining coordinates of corners of the planar surface; and
generating a modified digital image comprising a digital asset inserted onto the planar surface by utilizing a transformation matrix to perform a perspective transformation on the digital asset according to the coordinates of the corners.

15. The method of claim 14, wherein determining the coordinates of the corners of the planar surface comprises:
generating a contour image comprising an outer contour from the segmentation mask with a solid fill color inside the outer contour;
generating, utilizing an edge detection algorithm, an edge map by detecting a plurality of edges in the contour image;
determining a plurality of straight lines along the outer contour from the plurality of edges in the edge map; and
determining the coordinates of the corners from intersections of the plurality of straight lines.

16. The method of claim 15, wherein determining the coordinates of the corners of the planar surface further comprises:
determining candidate corner points from the intersections of the plurality of straight lines;
determining a shape formed by the candidate corner points;
generating an intersection-over-union metric between the segmentation mask and the shape formed by the candidate corner points; and
determining the coordinates of the corners in response to determining that the intersection-over-union metric is at least a threshold intersection-over-union value.

17. A non-transitory computer readable medium storing executable instructions which, when executed by a processing device, cause the processing device to perform operations comprising:
generating, utilizing a segmentation neural network, a segmentation mask for a planar surface in a digital image;
determining, utilizing a corner detection model, coordinates of corners of the planar surface from an outer contour extracted from the segmentation mask; and
generating, for display via a graphical user interface displaying the digital image, a modified digital image comprising a digital asset inserted onto the planar surface by performing a perspective transformation on the digital asset utilizing a transformation matrix determined from the coordinates of the corners of the planar surface.

18. The non-transitory computer readable medium of claim 17, wherein determining the coordinates of the corners of the planar surface comprises:
detecting a plurality of edges of the outer contour utilizing an edge detection algorithm;
determining sets of one or more straight lines along the outer contour from the plurality of edges utilizing a Hough transform with a plurality of threshold intersection values;
determining a filtered set of straight lines from the sets of one or more straight lines according to a distance threshold and an angle threshold; and
determining the coordinates of the corners from intersections of the filtered set of straight lines.

19. The non-transitory computer readable medium of claim 17, wherein generating the modified digital image comprises:
generating a transformation matrix from source points corresponding to corners of the digital asset to destination points corresponding to the coordinates of the corners of the planar surface; and
executing a function to perform the perspective transformation on the digital asset by applying the transformation matrix to a plurality of pixels of the digital asset.

20. The non-transitory computer readable medium of claim 17, wherein the operations further comprise:
generating a training dataset comprising a plurality of modified digital images by:
classifying, utilizing a classifier model, a plurality of digital images as planar surface images or non-planar surface images; and
generating the plurality of modified digital images by augmenting the planar surface images utilizing a multiply blending filter or a perspective transformation; and
training, utilizing the training dataset, the segmentation neural network to detect planar surfaces in digital images.
